(19) United States
(12) Patent Application Publication
(10) Pub. No.: US 2024/0365075 A1
(43) Pub. Date: Oct. 31, 2024

(54) EAR INTERFACES AND ASSOCIATED SYSTEMS, METHODS, AND NON-TRANSITORY COMPUTER-READABLE MEDIA

(71) Applicant: Iyo Inc., Redwood City, CA (US)

(72) Inventors: Neil David Treat, Los Gatos, CA (US); Matthew David Day, Oakland, CA (US); Daniel B. Sargent, San Francisco, CA (US); Jason Steven Rugolo, Gilbert, AZ (US)

(73) Assignee: Iyo Inc., Redwood City, CA (US)

(21) Appl. No.: 18/647,500

(22) Filed: Apr. 26, 2024

Related U.S. Application Data
(60) Provisional application No. 63/498,455, filed on Apr. 26, 2023.

(51) Int. Cl. H04R 25/00; G06T 7/00; G06T 7/50

(52) U.S. Cl. CPC H04R 25/659; G06T 7/0002; G06T 7/50; H04R 25/505; H04R 25/652; G06T 2200/24; G06T 2207/10016; G06T 2207/30004

(57) ABSTRACT

An ear interface is described. An example ear interface comprises a proximal portion and a distal portion, a first opening at the proximal portion, a first cavity and a second cavity extending away from the first opening. The first cavity has a first partial generally capsule shape, and the second cavity has a second partial generally capsule shape. The ear interface further comprises a second opening at the distal portion and a passage extending from the first cavity to the second opening. Methods of manufacturing ear interfaces are also described. An example method comprises receiving a digital representation of an ear impression and creating, based on the digital representation, a mold structured to form an ear interface. The mold is filled with a biocompatible material, the mold and the ear interface are separated, and a surface of the ear interface is finished.

### CROSS-REFERENCE TO RELATED APPLICATIONS

This application claims priority to U.S. Provisional Patent Application No. 63/498,455, filed on Apr. 26, 2023, and entitled “EAR IMPRESSION KIT AND ASSOCIATED SYSTEMS, METHODS, AND NON-TRANSITORY COMPUTER-READABLE MEDIA”, which is incorporated by reference herein in its entirety.

### TECHNICAL FIELD

The present technology generally relates to ear interfaces, and more particularly to custom ear interfaces, and associated methods of manufacturing custom ear interfaces.

### BACKGROUND

Audiologists may create ear impressions of a person's ears that may be used to create a device for the person, such as hearing aids, that use custom ear molds based on the ear impressions.

### SUMMARY

In some aspects, the techniques described herein relate to an ear interface including a proximal portion and a distal portion, a first opening at the proximal portion, a first cavity and a second cavity extending away from the first opening, the first cavity having a first partial generally capsule shape, the second cavity having a second partial generally capsule shape, a second opening at the distal portion, and a passage extending from the first cavity to the second opening.

In some aspects, the techniques described herein relate to an ear interface wherein a portion of the passage has a generally cylindrical shape.

In some aspects, the techniques described herein relate to an ear interface, further including a pressure-equalization vent having a third opening at one of the first cavity, the second cavity, and the passage, a fourth opening at an exterior of the ear interface, and a vent passage between the third opening and the fourth opening.

In some aspects, the techniques described herein relate to an ear interface, further including a hollow plug positioned within a portion of the vent passage.

In some aspects, the techniques described herein relate to an ear interface wherein the proximal portion and the distal portion include silicone.

In some aspects, the techniques described herein relate to a method including: receiving a digital representation of an ear impression; creating, based on the digital representation, a mold, the mold structured to form an ear interface that includes a proximal portion and a distal portion, a first opening at the proximal portion, a first cavity and a second cavity that extends away from the first opening, the first cavity has a first partial generally capsule shape, the second cavity has a second partial generally capsule shape, a second opening at the distal portion, and a passage extending from the first cavity to the second opening; filling the mold with a biocompatible material; separating the mold and the ear interface; and finishing a surface of the ear interface.

In some aspects, the techniques described herein relate to a method wherein the ear interface further includes a pressure-equalization vent having a third opening at one of the first cavity, the second cavity, and the passage, a fourth opening at an exterior of the ear interface, and a vent passage between the third opening and the fourth opening, and wherein the method further includes inserting a hollow plug into a portion of the vent passage.

In some aspects, the techniques described herein relate to a method, further including: receiving one or more images or videos of the ear impression; and determining, based on the one or more images or videos, that the ear impression meets a quality threshold.

In some aspects, the techniques described herein relate to a method wherein determining, based on the one or more images or videos, that the ear impression meets the quality threshold includes estimating, based on the one or more images or videos, a depth of the ear impression and determining that the ear impression meets the quality threshold based on the depth.

In some aspects, the techniques described herein relate to a method wherein determining, based on the one or more images or videos, that the ear impression meets the quality threshold includes estimating, based on the one or more images or videos, one or more reflectivities of one or more portions of an exterior surface of the ear impression and determining that the ear impression meets the quality threshold based on the one or more reflectivities.

In some aspects, the techniques described herein relate to a method, further including: receiving an order for a product that includes the ear interface; generating a user interface providing information regarding the product; and providing the user interface.

In some aspects, the techniques described herein relate to a method, further including providing instructions for positioning a fit disc assembly in a material placed into an ear to form the ear impression.

In some aspects, the techniques described herein relate to a method, further including: scanning the ear impression; and generating, based on scanning the ear impression, the digital representation of the ear impression.

In some aspects, the techniques described herein relate to one or more non-transitory computer-readable media including executable instructions that when executed by one or more processors of a system cause the system to perform a method, the method including: receiving a digital representation of an ear impression; creating, based on the digital representation, a mold, the mold structured to form an ear interface that includes a proximal portion and a distal portion, a first opening at the proximal portion, a first cavity and a second cavity that extends away from the first opening, the first cavity has a first partial generally capsule shape, the second cavity has a second partial generally capsule shape, a second opening at the distal portion, and a passage extending from the first cavity to the second opening; filling the mold with a biocompatible material; separating the mold and the ear interface; and finishing a surface of the ear interface.

In some aspects, the techniques described herein relate to one or more non-transitory computer-readable media wherein the ear interface further includes a pressure-equalization vent having a third opening at one of the first cavity, the second cavity, and the passage, a fourth opening at an exterior of the ear interface, and a vent passage between the third opening and the fourth opening, and wherein the method further includes inserting a hollow plug into a portion of the vent passage.

In some aspects, the techniques described herein relate to one or more non-transitory computer-readable media, the method further including: receiving one or more images or videos of the ear impression; and determining, based on the one or more images or videos, that the ear impression meets a quality threshold.

In some aspects, the techniques described herein relate to one or more non-transitory computer-readable media wherein determining, based on the one or more images or videos, that the ear impression meets the quality threshold includes estimating, based on the one or more images or videos, a depth of the ear impression and determining that the ear impression meets the quality threshold based on the depth.

In some aspects, the techniques described herein relate to one or more non-transitory computer-readable media wherein determining, based on the one or more images or videos, that the ear impression meets the quality threshold includes estimating, based on the one or more images or videos, one or more reflectivities of one or more portions of an exterior surface of the ear impression and determining that the ear impression meets the quality threshold based on the one or more reflectivities.

In some aspects, the techniques described herein relate to one or more non-transitory computer-readable media wherein the method further includes: receiving an order for a product that includes the ear interface; generating a user interface providing information regarding the product; and providing the user interface.

In some aspects, the techniques described herein relate to one or more non-transitory computer-readable media wherein the method further includes providing instructions for positioning a fit disc assembly in a material placed into an ear to form the ear impression.

### BRIEF DESCRIPTION OF THE DRAWINGS

FIG. 1 is a view of an ear interface according to some embodiments.

FIG. 2 is a front perspective view and a rear perspective view of an acoustic package that may be positioned in the ear interface of FIG. 1.

FIG. 3A is an exploded view of an ear-worn device that may include the ear interface of FIG. 1 and the acoustic package of FIG. 2.

FIG. 3B is a is a rear perspective view of an ear-worn device with an ear interface having a pressure-equalization vent in some embodiments.

FIG. 4A depicts components of a fit kit for creating ear impressions in some embodiments.

FIGS. 4B-4D depict views of fit disc assemblies that may be utilized in creating ear impressions according to some embodiments.

FIG. 5 is a block diagram depicting an example environment in which an ear interface manufacturing system may operate in some embodiments.

FIG. 6 is a block diagram depicting components of the ear interface manufacturing system in some embodiments.

FIG. 7 depicts a method of manufacturing ear interfaces according to some embodiments.

FIG. 8 depicts perspective views of stages of a method of manufacturing an ear interface in some embodiments.

FIG. 9 depicts a user interface that the ear interface manufacturing system may provide in some embodiments.

FIG. 10 is a block diagram of an example digital device in some embodiments.

Throughout the drawings, like reference numerals will be understood to refer to like parts, components, and structures.

### DETAILED DESCRIPTION

There are numerous problems and inefficiencies in current techniques for creating ear impressions and manufacturing ear interfaces. One problem is that an audiologist may use improper techniques in creating an ear impression of a person. This may result in an ear impression that does not accurately represent the ear or does not represent the ear sufficiently. Such deficiencies in the ear impression may not be discovered until after the person has left the audiologist appointment and there is no opportunity to create another ear impression without inconvenience to the person. Even worse, these deficiencies may not be discovered until after a custom ear interface based on the ear impression has been manufactured.

An ear-worn device may include a custom ear interface that is manufactured based on the ear impression. Another issue is that the ear impression may have to be created using specific techniques in order to ensure that the ear-worn device has the proper fit and aesthetics. Current approaches to creating ear impressions may not instruct audiologists on such specific techniques. Accordingly, ear impressions created using improper techniques may result in ill-fitting or aesthetically displeasing ear-worn devices.

Still another issue relates to lack of insight and visibility into the manufacture of a custom ear-worn device that a person has purchased. After the purchase, the person may schedule an audiologist appointment to have their ear impressions created. After the audiologist appointment, the person may not be informed as to when his or her custom ear-worn device will be manufactured and delivered to him or her. Such lack of visibility may deter the person from purchasing the ear-worn device at all.

Ear interfaces and methods of manufacturing ear interfaces as described herein provide technical solutions to these technical problems, as well as other advantages. In some embodiments, instructions are provided to audiologists on how to properly create ear impressions to ensure that ear-worn devices have the proper fit and aesthetics. Audiologists may be instructed to use fit disc assemblies to aid in properly creating ear impressions.

After creating ear impressions, the audiologists may capture images or videos of the ear impressions and provide the images or videos to an ear interface manufacturing system. The ear interface manufacturing system may analyze the images or videos to determine whether or not the ear impressions were properly created and will ensure proper fit and aesthetics. If not, the ear interface manufacturing system may inform the audiologist so that the audiologist may create additional ear impressions of the user.

The ear interface manufacturing system may control one or more devices or systems that are used to produce custom ear interfaces. Such devices or systems may include scanning devices that scan ear impressions, computing systems that generate digital representations or digital replicas of the ear impressions based on the scanning data, and manufacturing devices or systems that create molds based on the digital representations or digital replicas. Such devices or systems may also include devices that fill molds with biocompatible materials and devices that finish surfaces of ear impressions.

The ear interface manufacturing system may also provide to users who purchased custom ear-worn devices information regarding the production of the custom ear-worn devices. Accordingly, the users will have insight and visibility into the production and fulfillment processes.

Ear interfaces, the ear interface manufacturing system, and associated methods described herein provide significant advantages over previous technologies. Such advantages may include better fitting and more comfortable ear-worn devices that users can wear all day long. Moreover, there may be time savings for audiologists and users. Such advantages may also include more informed purchasing decisions by users due to the increased visibility into the production and fulfillment processes.

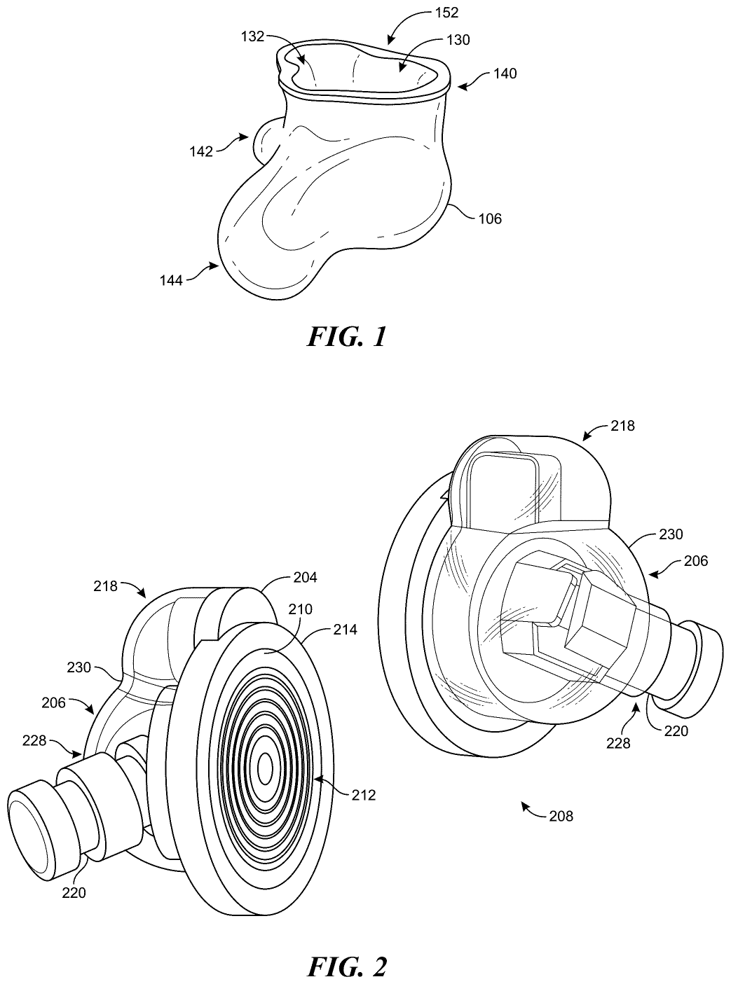

FIG. 1 is a view of an ear interface 106 according to some embodiments. The ear interface 106 includes a proximal portion 140, an upper portion 142, and a distal portion 144. The ear interface 106 is for a left ear of a wearer. The upper portion 142 is structured to be positioned at least partially in the cymba concha and the distal portion 144 is structured to be positioned at least partially in the ear canal. When the ear interface 106 is positioned in the left ear in this way, the proximal portion 140 faces away from the left ear.

The ear interface 106 also includes a first opening 152 at the proximal portion 140 and a first cavity 130 and a second cavity 132 extending away, or inwardly, from the first opening 152. The first cavity 130 has a first partial generally capsule shape. The second cavity 132 has a second partial generally capsule shape that is smaller than the first partial generally capsule shape.

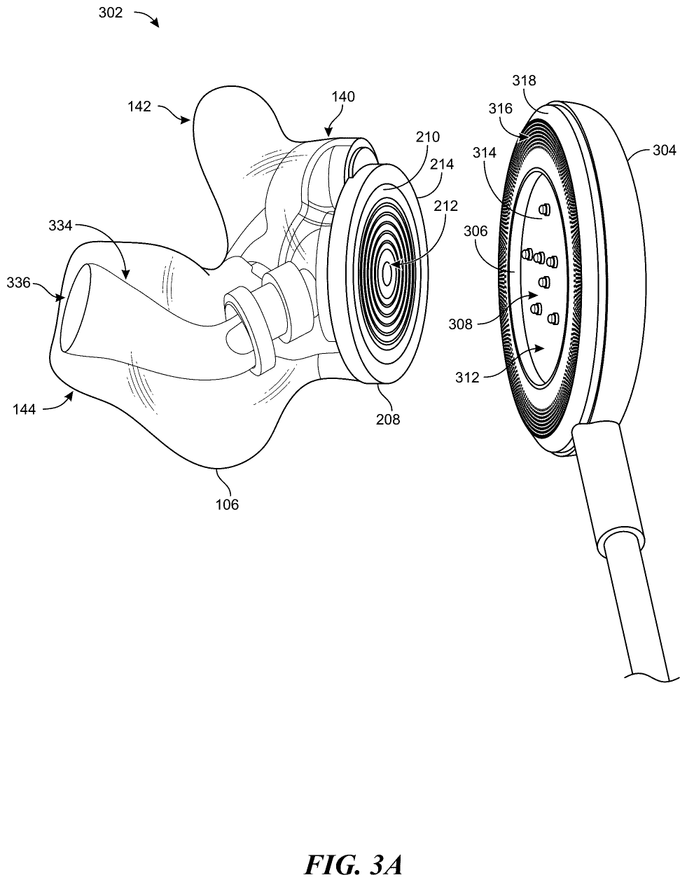

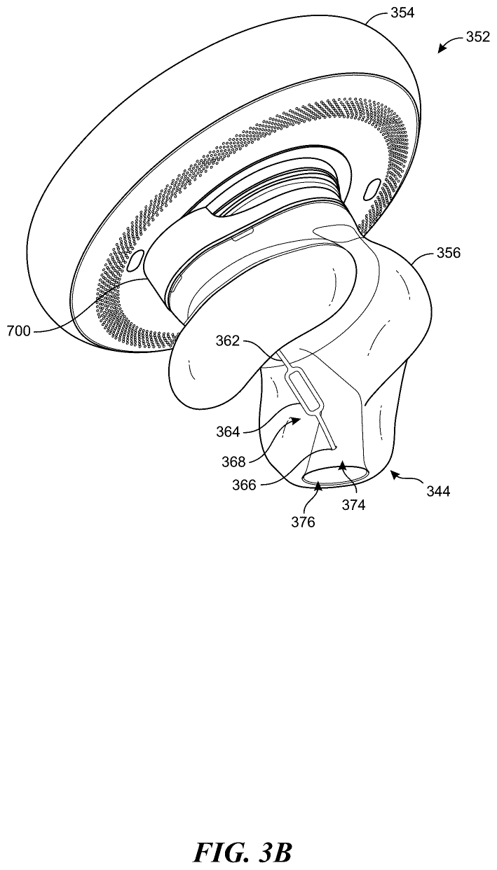

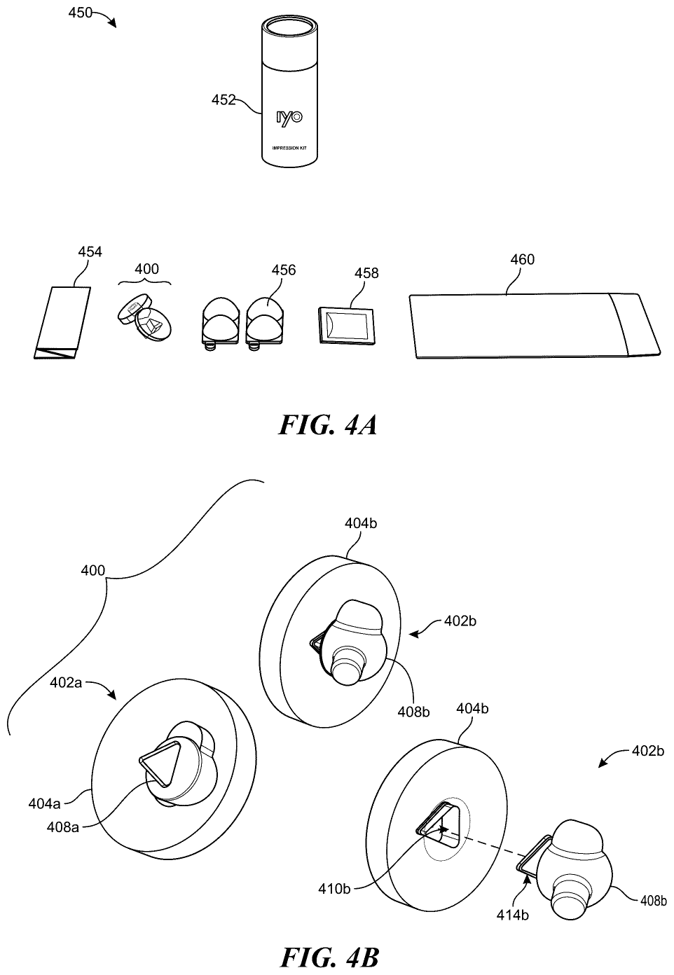

The ear interface 106 further includes a second opening (see FIG. 3A) at the distal portion 144 and a passage (see FIG. 3A) extending from the first cavity 130 to the second opening. A portion of the passage may have a generally cylindrical shape. As described with reference to FIG. 2, sound emitted by an acoustic package that is positioned within the ear interface 106 may pass through the passage and the second opening. The ear interface 106 may be made of any suitable biocompatible material, such as silicone.

FIG. 2 is a front perspective view and a rear perspective view of an acoustic package 208 that may be positioned in the ear interface 106 of FIG. 1. The acoustic package 208 includes a housing 230 that includes a first housing portion 206 having a first partial generally capsule shape and a second housing portion 218 having a second partial generally capsule shape. The first partial generally capsule shape of the first housing portion 206 may include a first partial generally cylindrical portion and a first partial generally hemispherical portion. Similarly, the second partial generally capsule shape of the second housing portion 218 may include a second partial generally cylindrical portion and a second partial generally hemispherical portion.

The housing 230 also includes a third housing portion 228 having a generally cylindrical shape. Positioned within the housing 230 are various components including one or more speakers, such as a driver and a balanced armature. The housing 230 may be made of any suitable material, such as polycarbonate, and may be transparent, translucent, or opaque. The acoustic package 208 also includes a magnet 214, a connector 210, a first set of electrical contacts 212 that are annularly arranged, and a cap 204. The acoustic package 208 also includes a snout 220, a portion of which is positioned in the third housing portion 228.

The first partial generally capsule shape of the first housing portion 206 generally matches the first partial generally capsule shape of the first cavity 130, and the second partial generally capsule shape of the second housing portion 218 generally matches the second partial generally capsule shape of the second cavity 132. Similarly, the generally cylindrical shape of the third housing portion 228 generally matches the generally cylindrical shape of the portion of the passage. Accordingly, the acoustic package 208 may be positioned at least partially within the ear interface 106, as depicted in FIG. 3A.

Example dimensions of the acoustic package 208 are as follows. In front elevational view, the housing 230 may have a length from an extremity of the first housing portion 206 to an extremity of the second housing portion 218 of about approximately 16 mm to about approximately 18 mm, such as approximately 16.4 mm, the first housing portion 206 may have a width of about approximately 12 mm to about approximately 14 mm, such as approximately 13.1 mm, and the second housing portion 218 may have a width of about approximately 6 mm to about approximately 8 mm, such as approximately 7.3 mm. In side view, the housing 230 may have a height of about approximately 8 mm to about approximately 10 mm, such as approximately 8.8 mm. The third housing portion 228 may have an outside diameter of about approximately 4 mm to about approximately 6 mm, such as approximately 5.0 mm. The first cavity 130, the second cavity 132, and the passage of the ear interface 106 may have similar example dimensions.

FIG. 3A is an exploded view of an ear-worn device 302 that may include the ear interface 106, the acoustic package 208, and an electronics package 304. The acoustic package 208 is positioned at least partially within the ear interface 106 The ear interface 106 includes a passage 334 extending to an opening 336 at the distal portion 144. The electronics package 304 includes a microphone cover 318 including multiple perforations 316. The electronics package 304 also includes a magnet 306 positioned inward relative to the microphone cover 318. The microphone cover 318 and the magnet 306 form a generally cylindrical recess 312 having a generally planar surface 314.

A second set of electrical contacts 308 extend outwards from the generally planar surface 314. Each electrical contact of the second set of electrical contacts 308 is configured to connect with a separate electrical contact of the first set of electrical contacts 212 so that power and/or data may pass between the electronics package 304 and the acoustic package 208. In some embodiments, the second set of electrical contacts 308 includes a set of pogo pins. In some embodiments, there are seven pogo pins in the set, and each pogo pin is arranged on the generally planar surface 314 such that the pogo pin contacts a separate annular electrical contact of the first set of electrical contacts 212.

The generally cylindrical recess 312 has the same general shape as the magnet 214 and the connector 210 of the acoustic package 208. The electronics package 304 may thus removably magnetically couple to the acoustic package 208. The electronics package 304 is removably magnetically coupleable to the acoustic package 208 due to attractive magnetic forces between the magnet 214 and the magnet 306. More details of the ear-worn device 302 and other ear-worn devices that include ear interfaces are described in U.S. patent application Ser. No. 18/622,540, entitled “VIRTUAL AUDITORY DISPLAY DEVICES AND ASSOCIATED SYSTEMS, METHODS, AND DEVICES” filed on Mar. 29, 2024, the entirety of which is incorporated by reference herein.

FIG. 3B is a rear perspective view of an ear-worn device 352 with an ear interface 356 having a pressure-equalization vent 368 in some embodiments. The ear-worn device 352 includes an electronics package 354 and an acoustic package coupled to the electronics package 354. The ear interface 356 has a passage 374 from the first cavity (not illustrated in FIG. 3B) to a second opening 376 at a distal portion 344 of the ear interface 356. The pressure-equalization vent 368 includes a first opening (not depicted in FIG. 3B) at an exterior of the ear interface 356. For example, the first opening may be at a middle portion of the ear interface 356 between a proximal portion of the ear interface 356 and the distal portion 344.

The pressure-equalization vent 368 also includes a second opening 366 at the passage 374 and a passage 362 between the first opening and the second opening 366. The diameter of the first opening or the second opening 366 may be approximately 0.1 mm, although the diameter of the first opening or the second opening may have other suitable sizes to allow for air passage. The passage 362 may have a diameter of approximately 0.1 mm at certain portions of the passage 362 and other diameters at other portions of the passage 362. A hollow plug 364 is positioned in the passage 362. The hollow plug 364 may function to ensure that air may travel through the passage 362. Air may pass through the first opening, the passage 362, and the second opening 366 to allow for static air pressure equalization between an air pressure in an ear canal of the wearer and an exterior air pressure without affecting the sound produced by the acoustic package. Furthermore, the pressure-equalization vent 368 may be sized to prevent undue ingress of particulate matter.

Although FIG. 3B depicts the pressure-equalization vent 368 having the second opening 366 in the passage 374, the second opening 366 may be in the first cavity, in the second cavity, or in another suitable cavity of the ear interface 356. The first opening may be at any suitable position in the ear interface 356. Accordingly, the pressure-equalization vent 368 may be in any suitable position in the ear interface 356 that allows for static air pressure equalization and provides acoustic resistance.

The pressure-equalization vent 368 may have any passage size or combination of passage sizes that allows for air flow between the exterior and the cavities of the ear interface 356 while maintaining the desired acoustic resistance properties. Furthermore, in some embodiments, the pressure-equalization vent 368 may include one or more layers of acoustic mesh. For example, the pressure-equalization vent 368 may have a passage size larger than 0.1 mm and include one or more layers of acoustic mesh. It will be appreciated that the pressure-equalization vent 368 may have varying passage sizes and/or configurations to allow for the passage of air while achieving desired acoustic resistance properties.

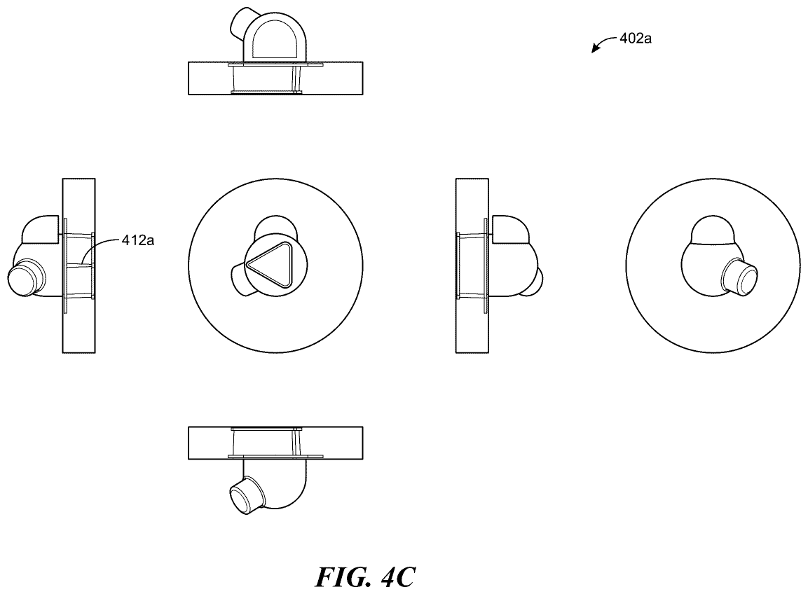

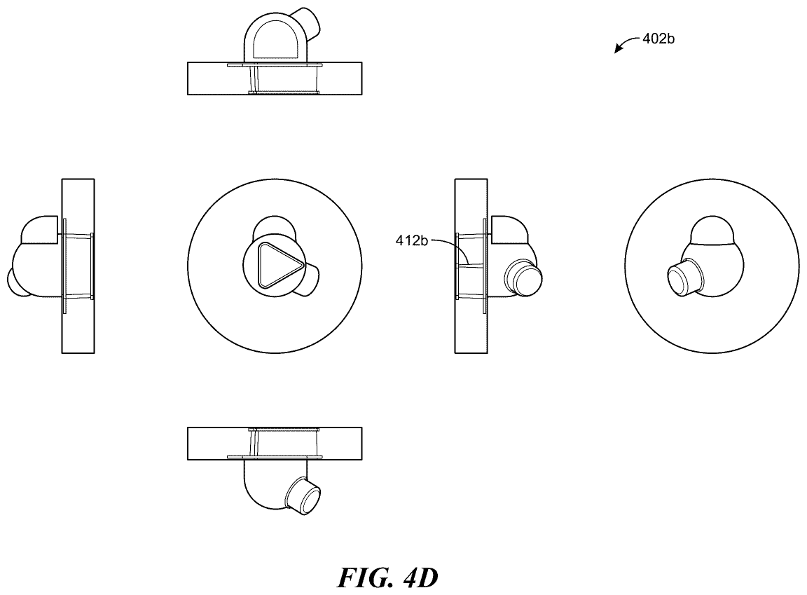

FIG. 4A depicts components 450 for creating ear impressions in some embodiments. The components 450 include packaging 452 in the form of a paper tube. The components 450 also include instructions 454, a pair of fit disc assemblies 400, ear impression material 456, hand sanitizer wipes 458, and a return mailer envelope 460.

When a customer places an order for an ear-worn device that includes a custom ear interface, the customer may be sent the packaging 452 and the other components disposed within the packaging 452. The customer may then take the components 450 to an audiologist so that the audiologist may create impressions of the customer's ears using the components 450. The components 450 may include fewer or more items than depicted, such as syringes, mixing tips, and ear dams. One advantage of the components 450 is that they may simplify the process of creating ear impressions for audiologists.

FIGS. 4B-4D depict views of the pair of fit disc assemblies 400 that may be utilized in creating ear impressions according to some embodiments. The pair of fit disc assemblies 400 include a fit disc assembly 402a for the left ear and a fit disc assembly 402b for the right ear. The fit disc assembly 402a includes a disc 404a and a pseudo acoustic package 408a. The fit disc assembly 402b includes a disc 404b and a pseudo acoustic package 408b. The disc 404b has a triangular opening on both sides leading to a triangular prism-shaped cavity 410b into which a triangular prism-shaped portion 414b of the pseudo acoustic package 408b may be inserted. The disc 404a and the pseudo acoustic package 408a are similarly structured.

An audiologist may utilize the fit disc assemblies 400 to ensure that ear-worn devices that include ear interfaces fit the user properly and are positioned in such a way that the ear-worn devices are aesthetically pleasing when worn. The disc 404a and the disc 404b may be made of transparent or translucent plastic and the pseudo acoustic package 408a and the pseudo acoustic package 408b may be made of colored plastic.

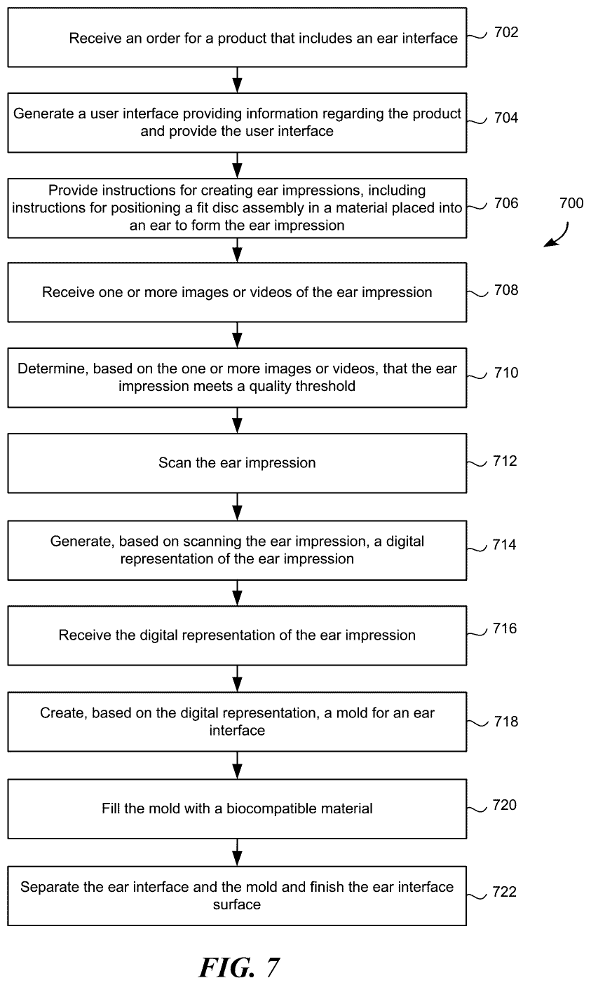

The disc 404a may include a transparent horizontal portion 412a (FIG. 4C) that allows a portion of the pseudo acoustic package 408a to be seen. The disc 404b may similarly include a transparent horizontal portion 412b (FIG. 4D) that allows a portion of the pseudo acoustic package 408a to be seen. The transparent horizontal portion 412a and transparent horizontal portion 412b may aid an audiologist in proper positioning of the fit disc assemblies 400 in the ear impression material 456 after the ear impression material 456 has been placed in the user's ears. More details as to how the audiologist may utilize the fit disc assemblies 400 is described, with reference to, for example, FIG. 7.

An ear interface manufacturing system may perform various aspects of the production of custom ear interfaces. For example, the ear interface manufacturing system may analyze images or videos of ear impressions to determine if the ear impressions meet quality thresholds. The ear interface manufacturing system may also control devices or systems that are used in manufacturing ear interfaces (for example, structured light scanners, additive manufacturing devices).

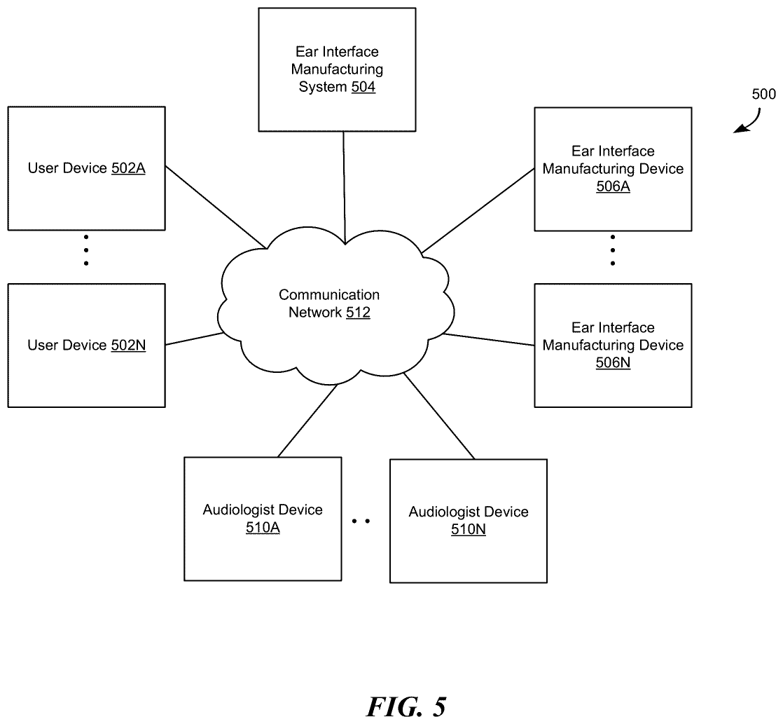

FIG. 5 is a block diagram depicting an example environment 500 in which an ear interface manufacturing system may operate in some embodiments. The environment 500 includes an ear interface manufacturing system 504, multiple user devices 502 (shown individually as user device 502A through user device 502N), multiple audiologist devices 510 (shown individually as audiologist device 510A through audiologist device 510N), multiple ear interface manufacturing devices 506 (shown individually as ear interface manufacturing device 506A through ear interface manufacturing device 506N), and a communication network 512.

The ear interface manufacturing system 504 may receive orders for ear-worn devices from users, cause the components 450 to be sent to users so that ear impressions may be created, and control the manufacturing of ear interfaces based on the ear impressions. The ear interface manufacturing system 504 may also provide user interfaces for audiologists that provide instructions for creating ear impressions and for users to order ear-worn devices and view product order status.

Users may utilize the multiple user devices 502 to order ear-worn devices and view product order status via the user interfaces provided by the ear interface manufacturing system 504. The ear interface manufacturing system 504 may provide or include a user application that may execute on the multiple user devices 502. The user application may provide the user interfaces.

Audiologists may utilize the multiple audiologist devices 510 to view instructions for creating ear impressions via the user interfaces provided by the ear interface manufacturing system 504. The ear interface manufacturing system 504 may provide or include an audiologist application that may execute on the multiple audiologist devices 510. The audiologist application may provide the user interfaces.

The multiple ear interface manufacturing devices 506 may include devices and/or systems that may be utilized to manufacture ear interfaces, such as structured light scanners, LIDAR (Light Detection and Ranging) devices, and/or cameras for scanning ear impressions and computing devices or systems for generating digital representations of the ear impressions based on the scans.

Other devices and/or systems that may be utilized to manufacture ear interfaces include additive manufacturing devices (for example, 3D printers such as stereolithographic (SLA) 3D printers) that may print ear interface molds, devices that fill the ear interface molds with silicone or other biocompatible materials to create the ear interfaces, and devices that may finish surfaces of ear interfaces (for example, polishers). As ear interfaces may be made of silicone, which is generally pliable, ear interfaces may be referred to as soft ear interfaces.

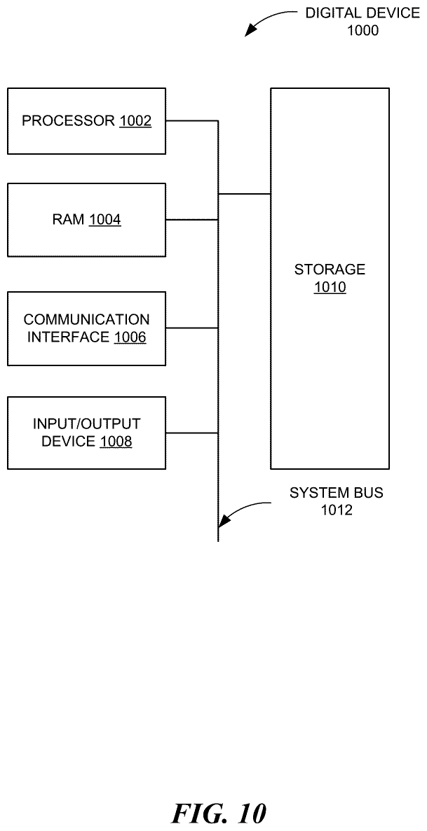

Each of the ear interface manufacturing system 504, the multiple user devices 502, the multiple audiologist devices 510, and the multiple ear interface manufacturing devices 506 may be or include any number of digital devices. A digital device is any device with at least one processor and memory. Digital devices are discussed further herein, for example, with reference to FIG. 10.

In some embodiments, the communication network 512 may represent one or more computer networks (for example, LAN, WAN, and/or the like). The communication network 512 may provide communication between any of the ear interface manufacturing system 504, the multiple user devices 502, the multiple ear interface manufacturing devices 506, and the multiple audiologist devices 510. In some implementations, the communication network 512 comprises computer devices, routers, cables, and/or other network topologies. In some embodiments, the communication network 512 may be wired and/or wireless. In various embodiments, the communication network 512 may comprise the Internet, one or more networks that may be public, private, IP-based, non-IP based, and so forth.

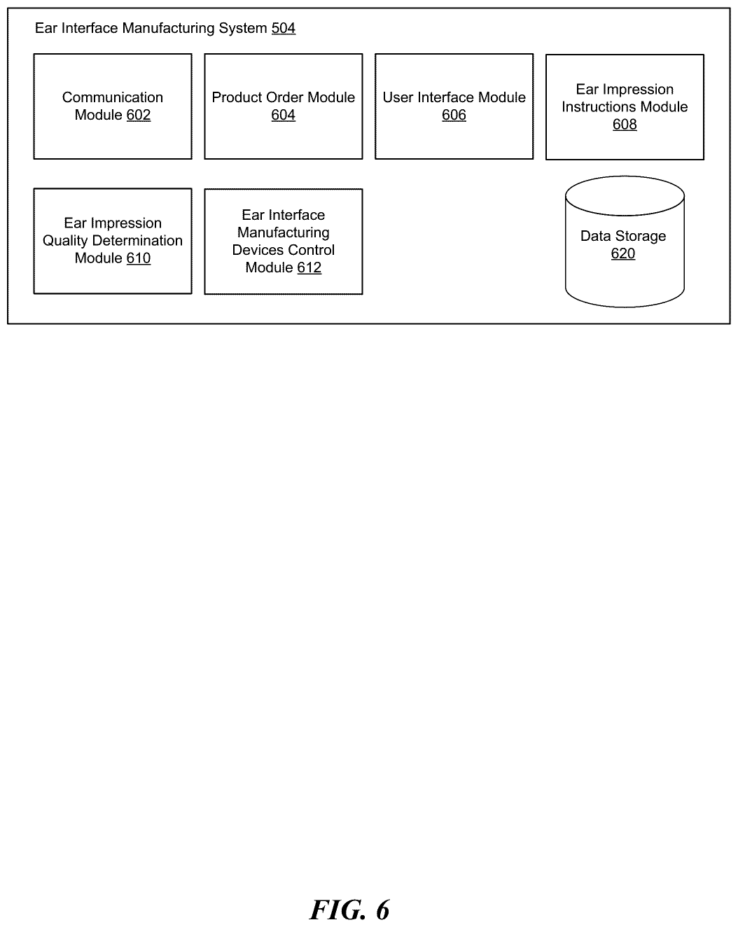

FIG. 6 is a block diagram depicting components of the ear interface manufacturing system 504 in some embodiments. The ear interface manufacturing system 504 may include a communication module 602, a product order module 604, a user interface module 606, an ear impression instructions module 608, an ear impression quality determination module 610, an ear interface manufacturing devices control module 612, and a data storage 620.

The communication module 602 may send requests and/or data between components of the ear interface manufacturing system 504 and any other components or devices, such as the multiple user devices 502, the multiple ear interface manufacturing devices 506, and/or the multiple audiologist devices 510. The communication module 602 may also receive requests and/or data between components of the ear interface manufacturing system 504 and any other components or devices.

The product order module 604 may receive orders for products that include ear interfaces. The user interface module 606 may generate user interfaces that provide information to users, such as user interfaces that provide product order information and user interfaces that provide instructions for creating ear impressions.

The ear impression instructions module 608 may provide instructions for creating ear impressions for audiologists. The ear impression quality determination module 610 may determine, based on one or more images or videos of an ear impression, whether or not an ear impression meets or exceeds a quality threshold.

The ear interface manufacturing devices control module 612 may control one or more ear interface manufacturing devices, such as scanning devices, mold creating devices, or devices that fill molds with biocompatible material that is used to create ear interfaces.

The data storage 620 may include data stored, accessed, and/or modified by any of the engines, components, modules or the like of the ear interface manufacturing system 504. The data storage 620 may include any number of data storage structures such as tables, databases, lists, and/or the like. The data storage 620 may include data that is stored in memory (for example, random access memory (RAM)), on disk, or some combination of in-memory and on-disk.

An engine, component, module, or the like of the ear interface manufacturing system 504 may be hardware, software, firmware, or any combination. For example, each engine, component, module or the like may include functions performed by dedicated hardware (for example, an Application-Specific Integrated Circuit (ASIC), a Field Programmable Gate Array (FPGA), or the like), software, instructions maintained in memory, and/or any combination. Software and/or firmware may be executed by one or more processors.

Although a limited number of engines, components, and modules are depicted in FIG. 6, there may be any number of engines, components, and modules or the like. Further, individual engines, components, and modules may perform any number of functions, including functions of multiple modules as described herein. Moreover, although the ear interface manufacturing system 504 may be depicted as having a single one of several engines, components, or modules, the ear interface manufacturing system 504 may have multiple engines, components, modules, or the like that perform a particular function.

FIG. 7 depicts a method 700 of manufacturing ear interfaces according to some embodiments. The ear interface manufacturing system 504 (for example, various modules thereof) may perform the method 700. The method 700 may begin at a step 702 where the ear interface manufacturing system 504 (for example, the product order module 604) may receive an order for a product that includes a custom ear interface, such as the ear-worn device 302 or the ear-worn device 352. At a step 704 the ear interface manufacturing system 504 (for example, the user interface module 606) may generate a user interface providing information regarding the product and provide the user interface for display to a user by, for example, a user device 502.

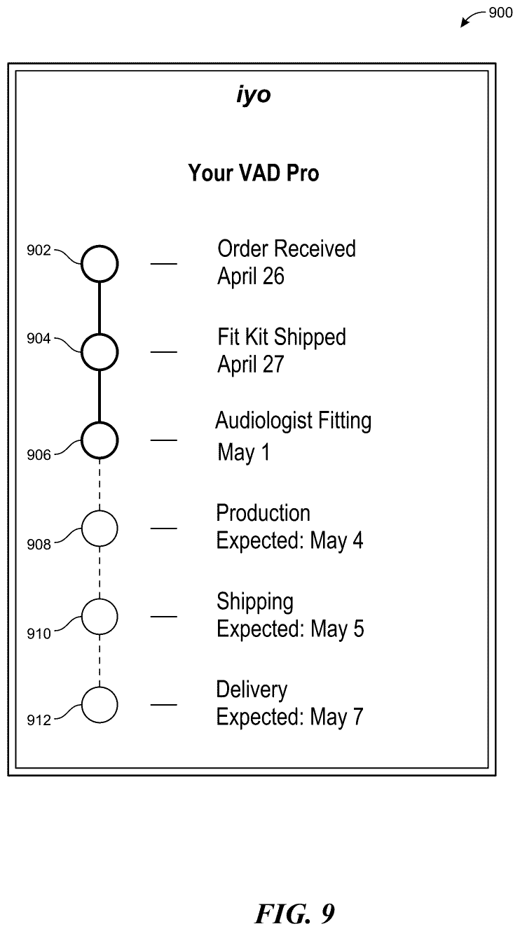

FIG. 9 depicts a user interface 900 that the ear interface manufacturing system 504 may provide to a user after the user has placed an order in some embodiments. The user interface 900 may display at which stage in the product order fulfillment process the user is in. The stages include an order received stage 902, a fit kit shipped stage 904, an audiologist fitting stage 906, a production stage 908, a shipping stage 910, and a delivery stage 912. The user interface 900 may indicate which stages are completed (for example, order received stage 902 through audiologist fitting stage 906 in the user interface 900), and which stages have yet to be completed (for example, production stage 908 through delivery stage 912 in the user interface 900).

The user interface 900 may allow the user to select any stage to see more information about the stage and/or to select options for certain stages. For example, at the audiologist fitting stage 906, the user may be able to select an audiologist to create the ear impressions for the user. As another example, at the production stage 908 the user may be able to specify or change options for the custom ear interfaces, such as color, texture, and/or opacity, or material for the custom ear interface.

Returning to FIG. 7, at a step 706, the ear interface manufacturing system 504 (for example, the ear impression instructions module 608) may provide instructions for creating ear impressions for audiologists. For example, the ear interface manufacturing system 504 may provide a user interface for an audiologist application that executes on an audiologist device 510 that provides instructions for creating ear impressions. The instructions may include instructions for positioning the fit disc assemblies 400 in materials placed into ears to form the ear impressions.

The audiologist application may allow audiologists to input user-specific information, such as ear canal dimensions and any unique requirements, to tailor the impression-taking process to each individual. The audiologist application may also offer tips and solutions for common issues encountered during the ear impression process, thereby helping audiologists overcome challenges and achieve optimal results.

For example, the instructions may instruct the audiologist to place the fit disc assembly 402a in the left ear of the user and the fit disc assembly 402b in the right ear of the user prior to filling the ears with the ear impression material (that is, to perform a dry fit). This will inform the audiologist of the best positions for the fit disc assembly 402a and the fit disc assembly 402b once the ears of the user are filled with the ear impression material.

It will be appreciated that the ear impression material may cure quickly and thus placing the fit disc assembly 402a and the fit disc assembly 402b may be time sensitive. Accordingly, instructing the audiologist to place the fit disc assembly 402a and the fit disc assembly 402b into the user's ears will aid the audiologist in proper placement of the fit disc assembly 402a and the fit disc assembly 402b in the ear impression material 456.

The instructions may instruct the audiologist to fill the ears of the user with the ear impression material 456, including the entire concha bowls of the ears. The audiologist may utilize a syringe to inject the ear impression material 456 into the ears of the user up to the second bends of the ear canals of the user.

The instructions may also instruct the audiologist to gently and quickly insert the fit disc assembly 402a into the ear impression material 456 in the left ear of the user and the fit disc assembly 402b into the ear impression material 456 in the right ear of the user. The audiologist may be instructed to place each fit disc assembly 402a and fit disc assembly 402b as close as possible to the ears of the user and to reduce or minimize gaps between the fit disc assembly 402a and the left ear and the fit disc assembly 402b and the right ear. The audiologist may also be instructed to position each fit disc assembly 402a and fit disc assembly 402b so that it is at least generally vertical.

The transparent horizontal portion 412a and the transparent horizontal portion 412b may aid the audiologist in positioning the fit disc assembly 402a and the fit disc assembly 402b. That is, the instructions may instruct the audiologist to position the fit disc assembly 402a and the fit disc assembly 402b such that the transparent horizontal portion 412a and the transparent horizontal portion 412b are both level and at either the 3 o'clock position (the fit disc assembly 402a) or the 9 o'clock position (the fit disc assembly 402b).

After the ear impression material 456 has sufficiently cured to form the ear impressions, the audiologist may remove the fit disc assembly 402a and the fit disc assembly 402b from the ear impressions and remove the ear impressions from the ears of the user. If properly created, the ear impressions will accurately represent the user's ears and will include cavities that match the shapes of the fit disc assembly 402a and the fit disc assembly 402b.

Certain ear impressions may not be properly created. For example, an ear impression may not be deep enough (for example, up to or past the second bend of the ear canal). As another example, an ear impression may not fully contact the relevant parts of the ear, such as the concha bowl. Ear interfaces manufactured using such ear impressions may not provide proper fit for the wearers.

To ensure that the ear impressions are of sufficient quality, the ear interface manufacturing system 504 may analyze one or more images or video of the ear impressions. The audiologist may capture one or more images or videos of each of the ear impressions using a mobile device such as a phone or tablet and send the one or more images or videos to the ear interface manufacturing system 504 for analysis. Additionally or alternatively, the audiologist may use a LIDAR device and/or a structured light scanner to capture one or more images and/or video of each of the ear impressions.

The ear interface manufacturing system 504 may receive the one or more images or videos at a step 708. At a step 710 the ear interface manufacturing system 504 (for example, the ear impression quality determination module 610) may determine, based on the one or more images or videos, whether or not the ear impression meets or exceeds a quality threshold. In some embodiments, the ear interface manufacturing system 504 estimates, based on the one or more images or videos, a depth of the ear impression (how far the ear impression extended into the ear canal). The ear interface manufacturing system 504 may then determine whether or not the ear impression meets or exceeds the quality threshold based on the estimated depth.

For example, the ear interface manufacturing system 504 may compare the estimated depth to a threshold depth. The ear interface manufacturing system 504 may determine that the ear impression meets or exceeds the quality threshold if the estimated depth meets or exceeds the threshold depth.

In some embodiments, the ear interface manufacturing system 504 determines, based on the one or more images or videos, whether or not the ear impression meets or exceeds the quality threshold by estimating one or more reflectivities of one or more portions of an exterior surface of the ear impression. An ear impression will have more of a matte appearance at surface portions where the ear impression material 456 contacted the ear of the user. This is due to the surface portions having more texture resulting from contact with skin, which has pores, which makes the surface portions appear non-shiny.

Surface portions of the ear impression where the ear impression material 456 did not contact the ear of the user will have and more of a shiny appearance. The degree or extent of reflectivity of light from a surface portion of an ear impression may be a proxy for contact with an ear. Accordingly, the degree or extent of reflectivity of light from the surface portions of the ear impression may be utilized to determine whether the ear impression meets or exceeds a quality threshold.

The ear interface manufacturing system 504 may estimate reflectivities of one or more portions of an exterior surface of the ear impression. The ear interface manufacturing system 504 may then determine whether or not the ear impression meets or exceeds the quality threshold based on the estimated one or more reflectivities.

For example, the ear interface manufacturing system 504 may compare the estimated one or more reflectivities to a threshold reflectivity. The ear interface manufacturing system 504 may determine that the ear impression meets or exceeds the quality threshold if none of the one or more reflectivities meet or exceed the threshold reflectivity. Additionally or alternatively, the ear interface manufacturing system 504 may determine that the ear impression meets or exceeds the quality threshold if an average reflectivity does not meet or exceed the threshold reflectivity. It will be appreciated that the ear interface manufacturing system 504 may utilize reflectivities of the exterior surface portions of the ear impression in various ways to determine whether or not the ear impression meets a quality threshold.

Additionally or alternatively, the ear interface manufacturing system 504 may use other techniques to determine if the ear impression meets a quality threshold. For example, based on the one or more images or video, the ear interface manufacturing system 504 may create a digital representation of the ear impression and attempt to identify key morphological features of the ear, such as the concha, helix, or antihelix. If the ear interface manufacturing system 504 is unable to identify key morphological features, the ear interface manufacturing system 504 may determine that the ear impression does not meet a quality threshold. Other techniques will be apparent.

If the ear interface manufacturing system 504 determines that the ear impression does not meet a quality threshold, the ear interface manufacturing system 504 may inform the audiologist that the ear impression is insufficient, and that the audiologist should create another ear impression. If both of the ear impressions meet the quality threshold, the audiologist may then send the ear impressions to a production facility using the return mailer envelope 460.

The ear interface manufacturing system 504 (for example, the ear interface manufacturing devices control module 612) may control one or more scanning devices to scan the ear impressions at a step 712. Scanning devices may include structured light scanners that use structured light patterns projected onto the ear impression to capture its three-dimensional shape. Structured light scanners typically offer high precision, fast scanning times, and are easy to use.

Scanning devices may also include LIDAR scanners that use lasers to measure the distance between the scanner and the ear impression. LIDAR software may then construct a 3D model of the ear impression based on the collected data. LIDAR scanners typically offer high resolution and are suitable for capturing intricate details and contours of an ear impression.

Additionally or alternatively, the ear interface manufacturing system 504 may control one or more cameras, such as phone or tablet cameras, to capture images or video of the ear impression from various angles. Software may be used to construct a 3D model based on the captured images or video.

At a step 714, the ear interface manufacturing system 504 may generate, based on the scanning of the ear impression, a digital representation of the ear impression. At a step 716 the ear interface manufacturing system 504 may receive the digital representation of the ear impression. At a step 718 the ear interface manufacturing system 504 may control one or more additive manufacturing devices (for example, 3D printers) to create, based on the digital representation, a mold for an interface.

The mold is structured to form an ear interface that includes a proximal portion and a distal portion, a first opening at the proximal portion, a first cavity and a second cavity that extends away from the first opening. The first cavity has a first partial generally capsule shape, and the second cavity has a second partial generally capsule shape. The ear interface also includes a second opening at the distal portion and a passage extending from the first cavity to the second opening. A portion of the passage has a generally cylindrical shape.

In some embodiments, the ear interface also includes a pressure-equalization vent that has a third opening at one of the first cavity, the second cavity, and the passage. The pressure-equalization vent also has a fourth opening at an exterior of the ear interface and a vent passage between the third opening and the fourth opening. In such embodiments, the mold is further structured to form the ear interface with the described pressure-equalization vent.

At a step 720 the ear interface manufacturing system 504 may control one or more devices to fill the mold with a biocompatible material, such as silicone, thermoplastic elastomers (TPE), or other biocompatible options. In some embodiments, a technician may fill the mold with the biocompatible material. Prior to filling, the mold may be cleaned.

After the biocompatible material has cured, the ear interface and the mold are separated, and the ear interface surface is finished (for example, polished, extra portions of biocompatible material removed, etc.) at a step 722. In some embodiments, mold may be made of friable material and a technician may manually separate the mold from the ear interface. For ear interfaces that include pressure-equalization vents, a hollow plug may be inserted into a portion of the vent passage.

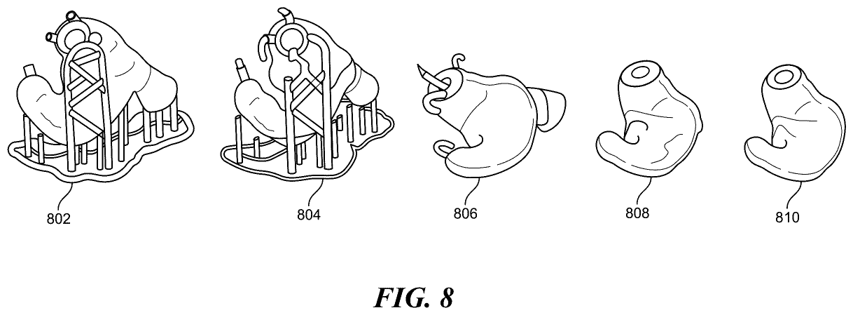

FIG. 8 depicts perspective views of stages of a method of manufacturing an ear interface in some embodiments. Stage 802 depicts a 3D printed mold and supports. Stage 804 depicts the 3D printed mold filled with silicone. Stage 806 depicts the 3D printed mold filled with silicone and with supports removed. Stage 808 depicts an ear interface separated from the 3D printed mold and with extra portions of biocompatible material removed. Stage 810 depicts the ear interface having a finished surface (for example, the surface has been polished).

FIG. 10 depicts a block diagram of an example digital device 1000 according to some embodiments. The digital device 1000 is shown in the form of a general-purpose computing device. The digital device 1000 includes at least one processor 1002, RAM 1004, communication interface 1006, input/output device 1008, storage 1010, and a system bus 1012 that couples various system components including storage 1010 to the at least one processor 1002. A system, such as a computing system, may be or include one or more of the digital device 1000.

System bus 1012 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1000 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1002 is configured to execute executable instructions (for example, programs). In some embodiments, the at least one processor 1002 comprises circuitry or any processor capable of processing the executable instructions.

In some embodiments, RAM 1004 stores programs and/or data. In various embodiments, working data is stored within RAM 1004. The data within RAM 1004 may be cleared or ultimately transferred to storage 1010, such as prior to reset and/or powering down the digital device 1000.

In some embodiments, the digital device 1000 is coupled to a network via communication interface 1006. The digital device 1000 can communicate with one or more networks such as a local area network (LAN), a general wide area network (WAN), and/or a public network (for example, the Internet).

In some embodiments, input/output device 1008 is any device that inputs data (for example, mouse, keyboard, stylus, sensors, etc.) or outputs data (for example, speaker, display, virtual reality headset).

In some embodiments, storage 1010 can include computer system readable media in the form of non-volatile memory, such as read only memory (ROM), programmable read only memory (PROM), solid-state drives (SSD), flash memory, and/or cache memory. Storage 1010 may further include other removable/non-removable, volatile/non-volatile computer system storage media. By way of example only, storage 1010 can be provided for reading from and writing to a non-removable, non-volatile magnetic media. The storage 1010 may include a non-transitory computer-readable medium, or multiple non-transitory computer-readable media, which stores programs or applications for performing functions such as those described herein with reference to, for example, FIG. 6. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1012 by one or more data media interfaces. As will be further depicted and described below, storage 1010 may include at least one program product having a set (for example, at least one) of program modules that are configured to carry out the functions of embodiments of the disclosure. In some embodiments, RAM 1004 is found within storage 1010.

Programs/utilities, having a set (at least one) of program modules, such as the ear interface manufacturing system 504, may be stored in storage 1010 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the disclosure as described herein.

It should be understood that although not shown, other hardware and/or software components could be used in conjunction with the digital device 1000. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

It may be apparent that various modifications may be made, and other embodiments may be used without departing from the broader scope of the discussion herein. For example, the ear interface manufacturing system 504 may provide instructions to audiologists via an application executing on the audiologist devices 510 in addition to or as an alternative to the instructions 454 included in the components 450. As another example, the ear interface manufacturing system 504 may use other molding techniques to create molds for ear interfaces, such as injection molding.

Another possible modification is that scans of ear impressions may be performed by systems other than the ear interface manufacturing system 504. For example, an audiologist may use a structured light scanner to scan ear impressions and send the scanned data to the ear interface manufacturing system 504. The ear interface manufacturing system 504 may perform quality checks on the scanned data and use the scanned data to create digital representations of the ear impressions.

As another example, instead of creating a mold, the ear interface manufacturing system 504 may directly manufacture an ear interface based on a digital representation of the ear impression, using suitable biocompatible materials.

Another modification is that the ear interface manufacturing system 504 may receive digital representations of ear impressions that a user had created at previously or according to a different process. The ear interface manufacturing system 504 may then analyze the digital representations to ensure that they are of the required quality. If so, the ear interface manufacturing system 504 may then manufacture ear interfaces based off the received digital representations.

Therefore, these and other variations upon the example embodiments are intended to be covered by the disclosure herein.

I/We claim:

1. An ear interface comprising a proximal portion and a distal portion, a first opening at the proximal portion, a first cavity and a second cavity extending away from the first opening, the first cavity having a first partial generally capsule shape, the second cavity having a second partial generally capsule shape, a second opening at the distal portion, and a passage extending from the first cavity to the second opening.

2. The ear interface of claim 1 wherein a portion of the passage has a generally cylindrical shape.

3. The ear interface of claim 2, further comprising a pressure-equalization vent having a third opening at one of the first cavity, the second cavity, and the passage, a fourth opening at an exterior of the ear interface, and a vent passage between the third opening and the fourth opening.

4. The ear interface of claim 3, further comprising a hollow plug positioned within a portion of the vent passage.

5. The ear interface of claim 1 wherein the proximal portion and the distal portion include silicone.

6. A method comprising:
receiving a digital representation of an ear impression;
creating, based on the digital representation, a mold, the mold structured to form an ear interface that includes a proximal portion and a distal portion, a first opening at the proximal portion, a first cavity and a second cavity that extends away from the first opening, the first cavity has a first partial generally capsule shape, the second cavity has a second partial generally capsule shape, a second opening at the distal portion, and a passage extending from the first cavity to the second opening;
filling the mold with a biocompatible material;
separating the mold and the ear interface; and
finishing a surface of the ear interface.

7. The method of claim 6 wherein the ear interface further includes a pressure-equalization vent having a third opening at one of the first cavity, the second cavity, and the passage, a fourth opening at an exterior of the ear interface, and a vent passage between the third opening and the fourth opening, and wherein the method further comprises inserting a hollow plug into a portion of the vent passage.

8. The method of claim 6, further comprising:
receiving one or more images or videos of the ear impression; and
determining, based on the one or more images or videos, that the ear impression meets a quality threshold.

9. The method of claim 8 wherein determining, based on the one or more images or videos, that the ear impression meets the quality threshold includes estimating, based on the one or more images or videos, a depth of the ear impression and determining that the ear impression meets the quality threshold based on the depth.

10. The method of claim 8 wherein determining, based on the one or more images or videos, that the ear impression meets the quality threshold includes estimating, based on the one or more images or videos, one or more reflectivities of one or more portions of an exterior surface of the ear impression and determining that the ear impression meets the quality threshold based on the one or more reflectivities.

11. The method of claim 6, further comprising:
receiving an order for a product that includes the ear interface;
generating a user interface providing information regarding the product; and
providing the user interface.

12. The method of claim 6, further comprising providing instructions for positioning a fit disc assembly in a material placed into an ear to form the ear impression.

13. The method of claim 6, further comprising:
scanning the ear impression; and
generating, based on scanning the ear impression, the digital representation of the ear impression.

14. One or more non-transitory computer-readable media comprising executable instructions that when executed by one or more processors of a system cause the system to perform a method, the method comprising:
receiving a digital representation of an ear impression;
creating, based on the digital representation, a mold, the mold structured to form an ear interface that includes a proximal portion and a distal portion, a first opening at the proximal portion, a first cavity and a second cavity that extends away from the first opening, the first cavity has a first partial generally capsule shape, the second cavity has a second partial generally capsule shape, a second opening at the distal portion, and a passage extending from the first cavity to the second opening;
filling the mold with a biocompatible material;
separating the mold and the ear interface; and
finishing a surface of the ear interface.

15. The one or more non-transitory computer-readable media of claim 14 wherein the ear interface further includes a pressure-equalization vent having a third opening at one of the first cavity, the second cavity, and the passage, a fourth opening at an exterior of the ear interface, and a vent passage between the third opening and the fourth opening, and wherein the method further comprises inserting a hollow plug into a portion of the vent passage.

16. The one or more non-transitory computer-readable media of claim 14, the method further comprising:
receiving one or more images or videos of the ear impression; and
determining, based on the one or more images or videos, that the ear impression meets a quality threshold.

17. The one or more non-transitory computer-readable media of claim 16 wherein determining, based on the one or more images or videos, that the ear impression meets the quality threshold includes estimating, based on the one or more images or videos, a depth of the ear impression and determining that the ear impression meets the quality threshold based on the depth.

18. The one or more non-transitory computer-readable media of claim 16 wherein determining, based on the one or more images or videos, that the ear impression meets the quality threshold includes estimating, based on the one or more images or videos, one or more reflectivities of one or more portions of an exterior surface of the ear impression and determining that the ear impression meets the quality threshold based on the one or more reflectivities.

19. The one or more non-transitory computer-readable media of claim 14 wherein the method further comprises:
receiving an order for a product that includes the ear interface;
generating a user interface providing information regarding the product; and
providing the user interface.

20. The one or more non-transitory computer-readable media of claim 14 wherein the method further comprises providing instructions for positioning a fit disc assembly in a material placed into an ear to form the ear impression.
